(19) United States
(12) Patent Application Publication
(10) Pub. No.: US 2008/0041483 A1
(43) Pub. Date: Feb. 21, 2008

(54) Duct and method of construction

(76) Inventor: William James Donnelly, Ivanhoe (AU)

Correspondence Address: GREER, BURNS & CRAIN, 300 S WACKER DR, 25TH FLOOR, CHICAGO, IL, 60606, US

(21) Appl. No.: 11/975,170

(22) Filed: Oct. 18, 2007

Related U.S. Application Data
(63) Continuation of application No. 10/117,382, filed on Apr. 5, 2002, now abandoned.

(51) Int. Cl. F16L 11/00

(52) U.S. Cl. 138/122; 138/133; 138/125; 138/131; 138/149

(57) ABSTRACT

A flexible duct construction and method of manufacture is provided in which the duct is formed from a continuously wound elongate member comprising a core of insulating material, a reinforcing wire element and a casing comprising a strip of substrate material extending around the core and the reinforcing element. In the preferred method of manufacture, adhesive is applied to one side of the strip of substrate, the casing has a tail part extending from a generally circular part which encapsulates the core and the reinforcing element, and the elongate encapsulated insulating member is wound helically so that the circular part of one winding overlies and adheres to the tail part of the previous winding.

### CROSS REFERENCE TO RELATED APPLICATIONS

This application is a continuation of application Ser. No. 10/117,382, filed on Apr. 5, 2002.

### BACKGROUND OF THE INVENTION

This invention relates to ducting and, more particularly, to an improved flexible duct construction of the kind suitable for use in ducted heating and air conditioning systems. The invention also relates to a method of and apparatus for manufacturing such a duct.

Many different forms of duct construction have been used in the past for heating and air conditioning duct construction, as well as in the construction of ducts for ventilation and air extraction systems.

Most previously proposed flexible duct constructions have a non-insulating core and require further processing to attach or contain an insulating medium such as fibreglass or a blanket of polyester fibre with a sheath of plastic or aluminum film being required to complete the duct.

In U.S. Pat. No. 5,210,947, there is described a flexible duct construction and method of manufacture in which a helically wound wire reinforcing element is embedded into the inner surface of a tubular casing of foam plastics. Such a duct construction has good insulating properties but can be expensive to manufacture requiring the electrically conductive wire to be heated to soften the internal wall of the foam casing to embed the wire in the foam casing.

It is therefore desirable to provide a fully insulated flexible duct construction which can be manufactured in a single continuous production process.

It is also desirable to provide an improved duct construction and method of manufacture which overcomes one or more of the disadvantages of known ducting constructions.

### SUMMARY OF THE INVENTION

According to a broad aspect of the invention there is provided a flexible tubular duct comprising: a core of insulating material; a wire-like reinforcing element; and a casing covering the core and the wire-like reinforcing element. Preferably, the casing comprises at least one strip of material covering the core and reinforcing material.

According to another aspect of the invention there is provided a flexible tubular duct formed from a continuously wound elongate member, wherein the continuously wound elongate member comprises:
a core of insulating material;
a wire-like reinforcing element; and
a casing comprising at least one strip of material covering the insulating core and the reinforcing element.

According to a further aspect of the invention, there is provided an elongate member for forming a flexible tubular duct comprising: a core of insulating material, a wire-like reinforcing element, and a casing comprising at least one strip of material covering the core and the reinforcing material.

In one embodiment, the insulating core is of tubular form and may be formed from an extruded foam plastics material, such as polyurethane, polyethylene, ethylene vinyl acetate (EVA) or other similar materials.

In another embodiment, the core may be formed from a fibrous insulating material. The wire-like reinforcing element preferably comprises a springy-type metal wire which extends alongside and substantially parallel to the tubular insulating core within the casing of material.

The casing may be formed of a strip of substrate material which extends around the insulating core and reinforcing element. Preferably the strip of substrate extends completely around the insulating core and reinforcing element to encapsulate the core and reinforcing element. Alternatively, the core and reinforcing element may be sandwiched between strips of substrate forming the casing. The substrate may comprise a polymeric plastics material such as polyester, polypropylene, polyvinyl chloride (PVC) or polyethylene. Alternatively, the substrate may comprise a metallic foil, such as aluminum foil, or a laminated or partially laminated material, such as a metal/plastics laminate.

The casing may be secured to the insulating core and reinforcing element by an adhesive. Various types of adhesives may be used such as urethane or polyester-based adhesives, epoxy-based adhesives, contact adhesives or hot melt glues. The choice of adhesive may be varied to suit different substrate and/or core materials.

According to yet another aspect of the invention there is provided a method of manufacturing a duct comprising the steps of:
providing an elongate core of insulating material;
providing a wire-like reinforcing element;
providing a strip of substrate material;
bending the strip of substrate material around the insulating core and reinforcing element to form an elongate encapsulated insulating member; and

winding the elongate encapsulated insulating member in a helical path to form a flexible tubular duct.

Preferably, the insulating core is of substantially circular cross-section and the strip of substrate material has a width greater than the circumference of the insulating core so that when the substrate is bent around the insulating core and reinforcing element, the substrate forms a casing which is generally P-shaped in cross-section, having a generally circular part and a tail part extending from the circular part. Preferably, the encapsulated insulating member is wound helically around a mandrel, in such a manner that the circular part of the casing of one winding overlies and preferably adheres to the tail part of the previous winding.

In a particularly preferred embodiment, the diameter of the insulating core is greater than the pitch of the helix developed in the winding process so that the sides of adjacent windings of the encapsulated member have greater areas of contact resulting in substantially straight sides of the wound insulating member.

When the elongate encapsulated insulating member is helically wound to form the duct, the outer part of the wound elongate member has a greater diameter than the inner part. The core of insulating material is usually manufactured from a foam plastics material having a natural elasticity that is able to accommodate the inner and outer diameter differential. However, the substrate material, such as a polymeric plastics substrate or metal plastics laminate, may not be able to accommodate the diameter differential without the substrate forming the radially outer part of the casing being stressed. In order to overcome this problem, heat and/or pressure may be applied to at least part of the substrate forming the radially outer part of the casing of the duct to induce stretching of said at least part of the substrate either before or during the winding process resulting in substantially non-stressed radially outer and inner parts of the casing.

According to a still further aspect of the invention there is provided apparatus for manufacturing ducting comprising a rotatable mandrel, substrate supplying means for supplying a strip of substrate to the mandrel, adhesive applying means for applying an adhesive to a surface of the substrate, core feeding means for feeding an elongate core onto the strip of substrate, wire feeding means for feeding a wire onto the strip of substrate alongside and substantially parallel to the core, means for bending the strip of substrate around the core and the wire to form a casing surrounding the core and wire in an encapsulated insulating member, and means for rotating the mandrel to wind the encapsulated insulating member in a helical path around the mandrel to form a tubular duct.

Preferably, the apparatus includes means for guiding the encapsulated insulating member as it is wound helically around the mandrel whereby the pitch of the helical winding is less than the external diameter of the encapsulated insulating member.

The apparatus may also include means for applying heat and/or pressure to at least part of the substrate forming the radially outer part of the casing of the duct.

In order that the present invention may be more readily understood, a preferred embodiment will now be described, by way of example only, with reference to the accompanying drawings.

### BRIEF DESCRIPTION OF THE DRAWINGS

FIG. 1 is a perspective view of a duct construction in accordance with the invention;

FIG. 2 is a enlarged view of part of the duct construction of FIG. 1;

FIG. 3 is an end view of an insulating core, a wire reinforcement and a strip for forming the duct construction of FIG. 1;

FIG. 4 is an end view similar to FIG. 3 showing the strip partially bent around the core and wire reinforcement; and

FIG. 5 is an end view of a generally P-shaped encapsulated insulating member formed from the core, wire reinforcement and strip of FIG. 3.

### DETAILED DESCRIPTION

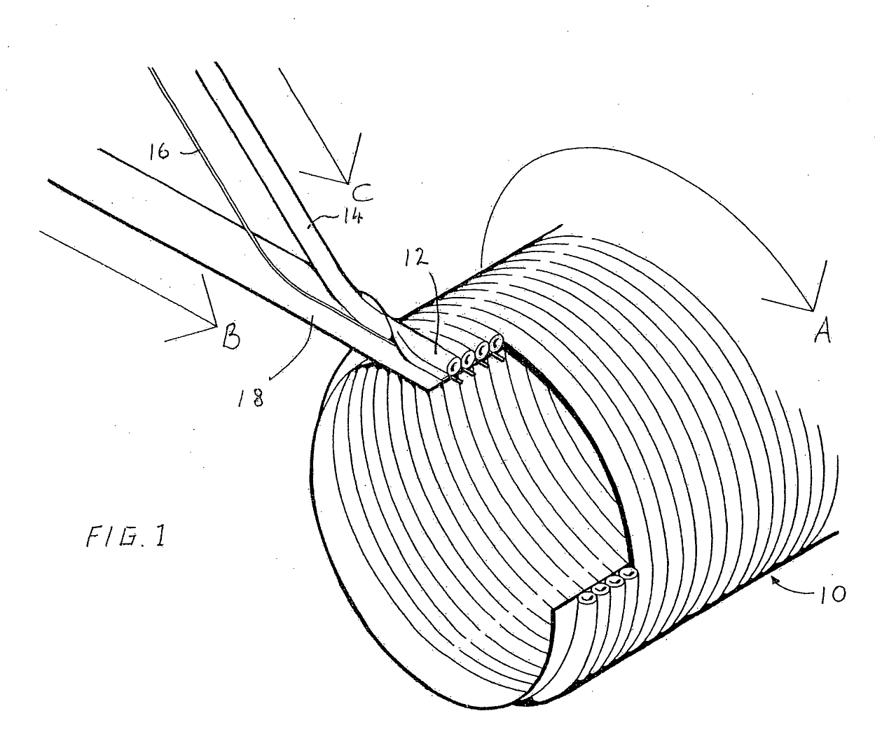

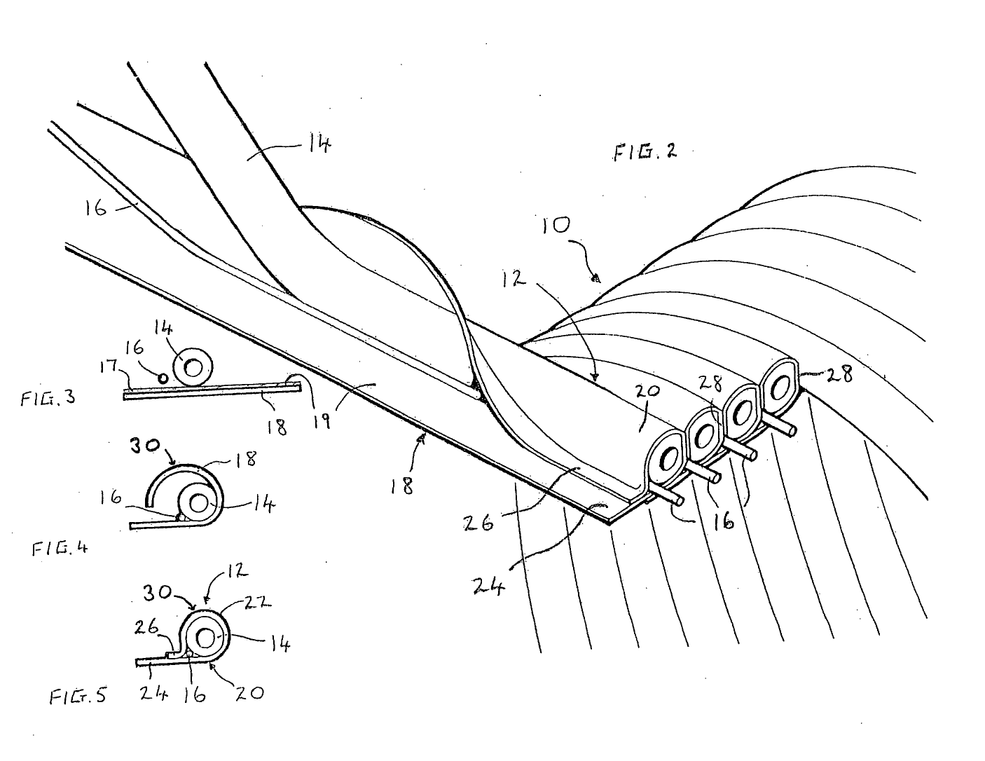

As shown in FIGS. 1 and 2 a tubular duct 10 is formed by winding an elongate encapsulated insulating member 12 in a helical path. Preferably, the encapsulated insulating member is wound around a mandrel (not shown) which may be rotated in the direction shown by arrow A to facilitate the winding process.

Referring more particularly to FIGS. 2 to 5, the elongate encapsulated insulating member 12 comprises an elongate core 14 of foam insulating material, a reinforcing wire element 16 and a casing formed from a strip of substrate material 18 which is bent around the core 14 and the reinforcing wire element 16 to form the encapsulated insulating member 12.

As shown, the core 14 is of tubular cross-section and may be formed of an extruded insulating foam plastics material such as polyurethane foam. Alternatively, a shaped core section of fibreglass, fibrous polyester or other fibrous insulating material may be substituted for the tubular foam core. The reinforcing wire element 16 is preferably formed from a springy-type metal wire, such as spring steel, which provides strength and structural integrity to the finished duct. The substrate strip 18 may be formed of a polymerized plastic material such as polyester, polypropylene, PVC or polyethylene. In cases where building codes or regulations insist on external duct surfaces being of metallic material, the substrate strip 18 may be formed of a metallic foil such as aluminum foil, or may comprise a metallic/plastic laminate.

In the method of the invention, the substrate strip 18 is fed from a roll of the strip in direction B to the mandrel, a layer of adhesive 17 is applied by an adhesive applicator to the surface on one side of the substrate strip 18, (the upper surface 19 as shown in FIG. 3) and the insulating core 14 and the reinforcing wire 16 are fed in direction C from a feeding station and laid upon the upper surface of the substrate strip 18 with the wire 16 extending alongside and substantially parallel to the foam core 14.

The substrate 18 is caused to be bent around the insulating core 14 and the reinforcing wire 16 as the substrate 18, core 14 and wire 16 are wound helically around the mandrel, so that the substrate 18 encapsulates and adheres to the core 14 and the wire. The width of the substrate strip 18 is greater than the external diameter of the insulating core 14 which in turn is substantially greater than the diameter of the reinforcing wire 16 so that in the encapsulated insulating member 12 the casing 20 formed from the strip 18 is generally P-shaped in cross-section having a generally circular part 22 which surrounds the core 14 and wire 16 and a tail 24 which extends substantially tangentially from the circular part. The end part 26 of the substrate strip 18 which is bent around the core 14 and wire adheres to the tail 24 of the generally P-shaped casing 20. As an alternative, the reinforcing wire 16 may be fed from a feeding station onto the strip as the substrate strip 18 is wrapped around the core 14 in the helical forming process.

As shown in FIG. 2, when the encapsulated member is helically wound to form the tubular duct, the sides 28 of the generally circular parts 22 of adjacent windings of the encapsulated member are flattened so as to have a greater surface area in contact with one another. This is achieved by making the pitch of the helix of the winding process less than the diameter of the tubular core 14. Therefore as the encapsulated member is wound on the mandrel the sides of the tubular foam core 14 are compressed inwardly to enable the flattened sides 28 of adjacent windings to be formed. The greater area of contact between the sides 28 of adjacent windings provides the advantage of better insulation resulting from a larger thermal barrier. Also, when the duct is formed into a bend, a gap is much less likely to open up between adjacent windings than in a duct with a smaller area of contact between adjacent windings.

When the elongate encapsulated insulating member 12 is wound to form the duct, it will be noted that the radially outer part 30 of the casing of the wound elongate member has a greater diameter than the inner tail part 24, which could lead to the outer part 30 of the casing being stressed in the winding process. Preferably, heat and/or pressure is applied to the outer part 30 to induce stretching of the outer part 30 of the casing 12 so that the outer part is substantially non-stressed in the resultant wound duct 10. Various methods may be utilized to apply heat and/or pressure to the outer part 30 of the casing. In one preferred method, air or an inert gas is injected by an injector between the insulating core 14 and the radially outer part 30 of the substrate strip 18 as it is wrapped around the insulating core 14 (FIG. 4) to create the required pressure on the outer part 30 of the strip 18. The injected air or other gas may be heated to assist the substrate in reaching its natural softening point, allowing the outer part of the substrate to stretch to accommodate the difference in inner and outer diameters.

In an alternative method, at least the part of the substrate strip 18 forming the radially outer part 30 of the casing is heated and impressed with an appropriate stretch pattern to accommodate the difference in inner and outer diameters of the casing.

The present invention thus provides an improved flexible duct having properties of good thermal insulation, structural strength and integrity. The invention also provides a method of continuously manufacturing ducting in a single process which is relatively simple and economical to perform.

It will be appreciated that various modifications may be made to the preferred embodiment described above without departing from the scope and spirit of the present invention. For example, in some instances, it may be desirable to substitute a shaped core section of fibreglass, fibrous polyester or other fibrous insulating material for the tubular foam core. In one modification, fibrous insulating and/or reinforcing material, such as fibreglass, may be applied to the surface of the substrate before, during or after the application of the adhesive. In a further modification, a blanket of fibrous insulating and/or reinforcement material may be wrapped around a tubular foam core before it is encapsulated by the substrate. An advantage of incorporating fibrous material, such as fibreglass, in the duct construction is to increase the strength of the duct so that is can support more weight and is less likely to be punctured in a fire or hazard situation.

1. A flexible tubular duct comprising a strip of flexible substrate material formed to have a round encapsulating portion which encapsulates a core of fibrous insulating material, wherein the round encapsulating portion is helically wound to form the tubular duct and the strip is also formed to have a tail portion extending from the encapsulating portion so that the encapsulating portion and the tail portion form a generally P-shaped cross-section, the duct also including a helically wound reinforcing element which is encapsulated by the strip of substrate material in the tubular duct.

2. The duct according to claim 1 wherein the encapsulating portion of each winding overlies the tail portion of an adjacent winding.

3. The duct according to claim 1 wherein the encapsulating portion of each winding overlies the tail portion of an adjacent winding.

4. The duct according to claim 2 wherein the encapsulating portion of each winding is secured by adhesive to the respective tail portion it overlies.

5. The duct according to claim 3 wherein the encapsulating portion of each winding is secured by adhesive to the respective tail portion it overlies.

6. The duct according to claim 1 wherein the substrate comprises a polymeric plastics material.

7. The duct according to claim 6 wherein the polymeric plastics material comprises any one of the following:
polyester, polypropylene, polyvinyl chloride (PVC) or polyethylene.

8. The duct according to claim 1 wherein the strip of substrate material comprises a metallic foil.

9. The duct according to claim 1 wherein the substrate material comprises a laminated or partially laminated material.

10. The duct according to claim 9 wherein the strip of substrate material comprises a metal/plastics laminate.

11. The duct according to claim 1 wherein the core of insulating material is of tubular form.

12. The duct according to claim 1 wherein the core of fibrous insulating material is formed from fibreglass, fibrous polyester or other fibrous insulating material.

13. The duct according to claim 1 wherein the reinforcing element is formed from metal wire.

14. The duct according to claim 1 wherein the reinforcing element extends substantially parallel to the insulating core.

15. The duct according to claim 1 wherein the round encapsulating portion is secured to the core of insulating material and to the reinforcing element by an adhesive.

16. The duct according to claim 1, in which each winding is secured by adhesive to its adjacent windings.

17. The duct according to claim 1 wherein upon said encapsulating portion being helically wound to form said strip with said core encapsulated, opposing surfaces of adjacent portions of said strip are flattened for enhancing insulating properties of said duct.

18. A flexible tubular duct comprising a strip of flexible substrate material formed to have a round encapsulating portion which encapsulates a core of plastic insulating material, wherein the round encapsulating portion is helically wound to form the tubular duct and the strip is also formed to have a tail portion extending from the encapsulating portion so that the encapsulating portion and the tail portion form a generally P-shaped cross-section, the duct also including a helically wound reinforcing element which is encapsulated by the strip of substrate material in the tubular duct.

19. The duct according to claim 18 wherein the core of insulating material is formed from an extruded foam plastics material.

20. The duct according to claim 18 wherein the core is formed from any one of the following:
polyurethane, polyethylene or ethylene vinyl acetate.
